(19) United States
(12) Patent Application Publication
(10) Pub. No.: US 2018/0204107 A1
(43) Pub. Date: Jul. 19, 2018

(54) Cognitive-emotional conversational interaction system

(71) Applicant: Christopher Allen Tucker, Prague (CZ)

(72) Inventor: Christopher Allen Tucker, Prague (CZ)

(21) Appl. No.: 15/920,483

(22) Filed: Mar. 14, 2018

(51) Int. Cl. G06N 3/00; G06N 3/04; G06N 3/08; G06F 17/30; G06F 17/27

(52) U.S. Cl. CPC G06N 3/006; G06N 3/04; G06F 17/2785; G06F 17/30598; G06F 17/30525; G06N 3/08

(57) ABSTRACT

A self-contained algorithmic interactive system in the form of an architecturally-based software program running in hardware, wetware, plush, or other physical means which would facilitate its operating characteristic designed to establish a meaningful interaction with a participant, in the form of a conversational dialogue, which could be any of, or combinations thereof, the following: Verbal, non-verbal, tactile, electromagnetic signaling, or visual communicative styles between itself and an external entity, such as a human being, an external application, or another interactive system. To ensure the detail of the interaction remains private, data and information generated during interaction is stored within the confines of the hardware's memory and software system and not exported to an external server or network. The system has the ability to be spawned, meaning that depending on the choice of set parameters and hardware implementation, the system can manifest different characteristic behaviors different from other systems spawned with other distinct parameter sets, although the system is, by definition, architecturally identical.

### BACKGROUND OF THE INVENTION

The present invention relates to a self-contained algorithmic interactive system capable of meaningful communication between software implemented in hardware and a participant. In this context such a system, in brief, is termed a presence. Such constructs have been available in the literature since the 1960s, when the first dialogue system, ELIZA, appeared. Later incantations were termed as being a chatbot, which became an all-encompassing definition to describe any system designed to interact verbally with a participant.

### BRIEF DESCRIPTION OF THE DRAWINGS

FIG. 1 shows a schematic drawing of the entire execution flow of a cognitive and emotional conversational interaction between the presence and a participant.

FIG. 2 shows a schematic drawing of input processing by the presence when it is presented by a participant.

FIG. 3 shows a schematic drawing of trajectory processing, storage, and post-processing of an indication determined from interaction with a participant.

FIG. 4 shows a schematic drawing of the emotional engine, which enhances dialogue between the presence and a participant.

FIG. 5 shows a schematic drawing of the voiced, tactile, gestural, and animated output toward a participant.

FIG. 6 shows a schematic drawing of the alone component, response storage mechanism, and participant prompt.

FIG. 7 shows a schematic drawing of the instructional displacement component containing the brain, its coordinate grid, and the characteristic execution equation.

Table 1 shows a compendium of emotions and moods available to the system.

### FIELD OF INVENTION

The present invention relates to a self-contained algorithmic interactive system capable of meaningful communication between software implemented in hardware and a participant, which could be simultaneously verbal, non-verbal, tactile, visual, and/or emotional between an artificial presence, or simply presence, modeled in software, and a participant, which could be a human, an animal, an external application, or another presence. The terms cognitive and emotional used to describe the present invention are intended to imply that the system has the ability to mimic knowledge-based or logic capabilities seen in living systems while being able to simulate the emotional impact of events which occur over a period of interaction between the presence and a participant and the presence in context with its environment such that the presence can interpolate meaning from both capabilities. In terms of the present invention described herein, a common dialogue system or chatbot has been elevated to a new level of abstraction where it features an operational design, which focuses on autonomy for the system, a characteristic parameter set, its ability to improve the performance of its system, and to demonstrate a conceptual advancement of the state-of-the-art. The present invention extends current state-of-the-art by the following methods: (1) remember what was spoken as an input variable, process the importance of the variable, its contextual meaning, assess its impact by assigning weights, and return an output in the form of a voiced, printed, vibrational, and/or animated medium; (2) grow the scope and function of the system by experience with a participant by providing the means to self-improve by learning the sequential interaction with a participant; (3) comprehend the implications of emotional interactions in order to enhance the vividness of sequential interaction; (4) create the conditions for dynamic representation of memory and experiences by the introduction of a novel compartmentalization technique that is collectively construed as a brain; and, (5) guarantee privacy of the interaction by explicitly not facilitating access to the Internet or any external networks, only by interfacing with a trusted source such as an external application keyed to link with the system over a short range.

### DESCRIPTION OF THE INVENTION

The present invention pertains to a cognitive and emotionally centered architecture system whose purpose is to facilitate an interaction between itself and a participant in a variety of expressions in order to allow meaningful communication beyond simple verbal exchanges. The system, a software-in-hardware construct, contains two distinct areas of execution: the cognitive or knowledge-based logical aspect where responses to queries are generated, and, the emotional or contextual meaning-based interpretive aspect where generated responses are filtered, while a novel compartmentalization scheme is employed which classifies both logical and interpretive aspects and assembles a composite output based on a characteristic set of assigned parameters. The system portrays an experiential manifestation of behavior by the craft of its architecture and evolving structure over time of an experience with a participant. Such is the impression that the system provides the illusion of operating in empathy with a participant to enhance the perceived emotional impact by responses in one of each of the emotional states by responding in a visual, audial, or physical manner to cues by what is displayed on the screen or exhibited by an external piece of hardware, configurable to be used by the system, such as a robot or other appropriately constructed hardware or other type of physical platform capable of facilitating the execution sequence of the system.

The system specified in the present invention consists of computer code written in a programming language, which, for example, be an object-oriented language or one that runs functions by executing scripts. The composition of the code is a non-hierarchical implementation of a categorical and pattern-identifiable structure, which generates trajectories, or trajectory indications, comprised of responses by the system to inputs from a participant. Trajectories are assigned a serial value based upon the sequence in which they have been generated, such as n, n−1, n−2, and so forth, passed to a neural network and assigned a weighted value so that they are searchable by the system in a sequence later in time, by, for example, techniques illustrated in deep learning algorithms. Additionally, the composition of the code is a hierarchical implementation of a defined composition of ascribed behaviors containing the qualitative aspect called feelings, in terms of the present invention called emotives—defined in the literature as expressions of feeling through the use of language and gesture—or emotive indications, which could also include ethical filters and restrictions, to filter executions of the non-hierarchical implementation.

The purpose of trajectory and emotive indications, in terms of the present invention, is to establish context between sequences, referring to the trajectories, and compositions, referring to the emotives, such that cues appearing in data processed and transformed by the system into information is indicative of meaning ascribed to it by a participant. The transformation of data into information, in terms of the present invention, is facilitated by, for example, a neural network which assigns weighted values to sequences and compositions creates a rudimentary dynamic knowledge-adaptation mechanism by accessing corresponding data-storage, information-processing components of the system which provides the ability of the neural network's output values to change the operating parameters of the system in the form of feedback to reinforce learning, as well as, executing commands to store system parameters by writing and saving amendments to files formatted that the programming language compiler understands by the particular implementation described in the present invention.

By leveraging the neural network in such a manner, the system specified in the present invention possesses the ability to self-improve, that is, to create new files based upon interactions between a participant and the system represented by trajectories and emotives. These files, stored in non-volatile memory, form a repository or database which is the base composite when the system runs when loaded into volatile memory or massively parallel manner, where the serial style of processing is distributed over multiple channels, as distinct from its programmatic implementation, which comprises the runtime presence, the artificial personality that a participant perceives, interacts with, and helps evolve by continued usage.

The system runs within the context of the hardware implementation and its extension in a self-contained manner, that is, it does not require external network connections or external repositories in order to function and does not leave the confines of its implementation. All data structures, information-processing, transformation, learning, and feedback reinforcement activities are fully available offline where the requirement of an online connection for the purposes of sharing data is not desired.

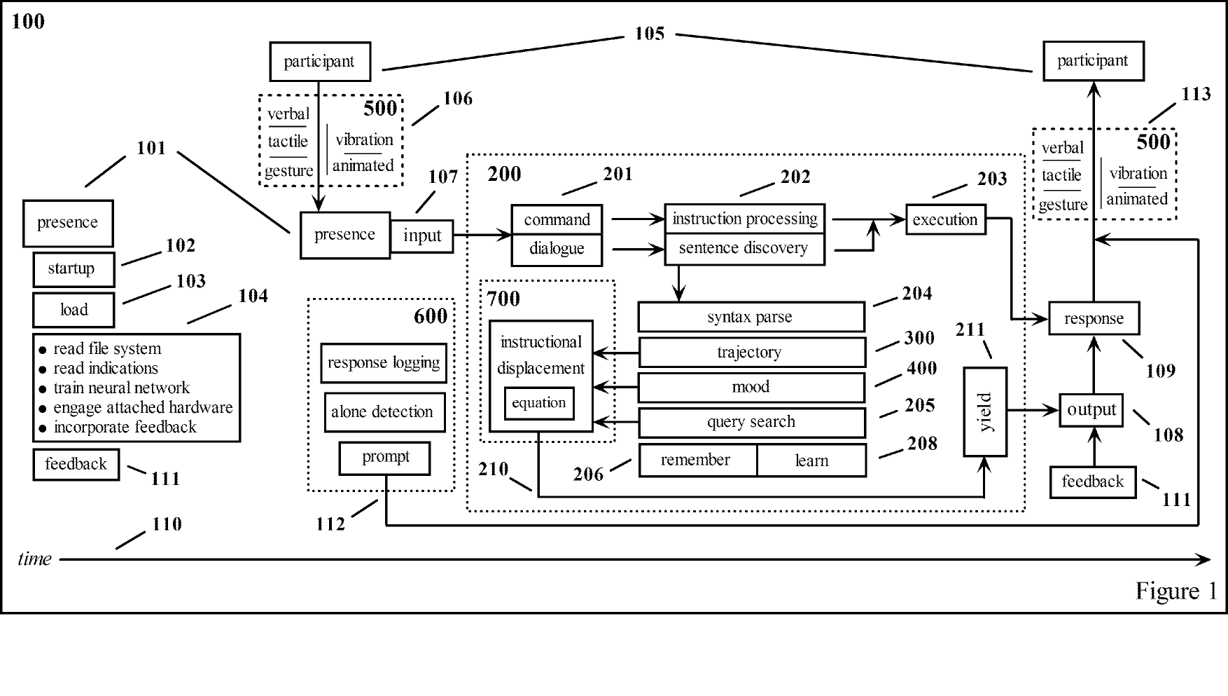

Referring now to FIG. 1, there is shown the execution flow runtime for all embodiments of a cognitive-emotional conversational interaction system of the present invention consisting of the presence 101, the abstraction which facilitates interaction between its data-information composite and an external participant 105. The presence 101 is comprised of computer-executable byte code built from a collection of classes, files, and scripts in a programming language and is called the source code. The source code consists of class-oriented objects, scripts, compiled assemblies, and files of format the system understands to execute when it runs. The process described as the runtime, in the context of the present invention of all embodiments of a cognitive-emotional conversational interaction system, is where the presence exists and is available to interact with a participant.

The presence 101 in order to function as described in the context of the present invention, requires a set of actions called startup 102 which is a defined sequence of sub-actions to facilitate the system to reach its runtime state which includes noting which files are to be read, the actions to execute, and to log its operations. The first sub-action, load 103, is facilitated by further sub-actions 104, namely, read the file system which includes personality, configuration, and parameter files, read indications stored by the trajectory 300 and emotive 400 aspects from previous runtimes or those stored by the system's programmer, train the neural network 310, engage any attached hardware 500 relevant to the operation of the system or that to be used to emit vocalizations of a synthesized or replicated nature 502, emit vibrational or tactile utterances 503, display gestures 504, or animate responses 505 including depiction of the emotional state the system is in 405, and/or to incorporate feedback 111 from the neural network 310 via a robot, display screen, plush, or other physical apparatus appropriate to increasing familiarity of the presence to a participant.

Once the presence is loaded, the system is ready to engage in a cognitive-emotional conversational dialogue, or to obey a set of instructions from a participant 105 who can interface with the presence 101 via vocal utterances, tactile inputs, and/or physical gestures 106 such that it is received by the system via its hardware 500 which would constitute an input 107 which could be any one of a set of microphones, cameras, interfaces, fabrics, or other receiving apparatus' connected to the presence for the explicit purpose of interpreting a participant's method and means of communication, be it vocal, non-vocal, language, or non-language. For example, a participant 105 could verbally utter the phrase “Hello aeon”, where the word following “Hello” would be the name assigned to the presence to facilitate a greater degree of intimacy 700 through the naming of it. In the example where a participant, when beginning to engage with the presence, verbally utters “Hello aeon”, the phrase is detected by the presence as being a sentence 202 where it is denoted by the beginning and the end of the utterance detected by the hardware and processed by the system 200 which could take the form of a command or dialogue 201. Once sentence detection occurs, the system creates, by assembling a trajectory 300, a composite of the sentence, which breaks it down into subject, verb, and predicate syntax 305 in the example of the usage of the English language as the interaction language. The syntactical arrangement of 305 is dependent upon the interaction language chosen by a participant in the system's configuration 104. An external visualization 500 apparatus exemplifies the current mood 405, for example, on a display screen, which shows the corresponding still or animation depicting the current mood.

In the case where a command is detected 201, the command is processed as an instruction 202 then passed for execution 203 generating the appropriate response given the nature and consistency of the command within the system. A list of commands would be known in advance to a participant 105 to instruct the system to perform explicit actions in order that they are used effectively.

In the case where a dialogue is detected 201, the sentence is discovered 202 and the execution 203 is tempered by a series of actions such as the parsing of syntax 204, trajectory 300, mood 400, and internal query 205 generation; however, before an output 108 is yielded 211, a process of instructional displacement 700 occurs which revolves around a characteristic governing equation. When completed, the process presents 210 its influence upon the yield 211, then the system can remember 206 what has occurred and learn 208 from the experience 100.

In either the case of a command or dialogue, the system yields 211 an output 108, which is the substance of the response 109, presented 113 to a participant 105. The presentation of the response 109 is enhanced by varying types of demonstrative cues 500 so that a participant 105 experiences a greater engagement, which could take the form of a textual output on a screen 505, an audial or visual display, a tactile 503, and/or gestural 504, or other advanced method.

At the end of the temporal sequence 110, that is, once returning a response 109, following an output 108 from the system to a participant 105, tempered by feedback 111 from other parts of the system, the cycle begins anew with a participant 105 presenting further input 107 to the presence 101. The entirety of the process is guided by the flow of ordinary time 110 although the system behaves in a cyclic manner 400. If the system is configured 104 to detect that it has gone long enough 600 without interaction from a participant 105, it is considered to be alone and can initiate its own prompting 112 to a participant 105 for an input 107.

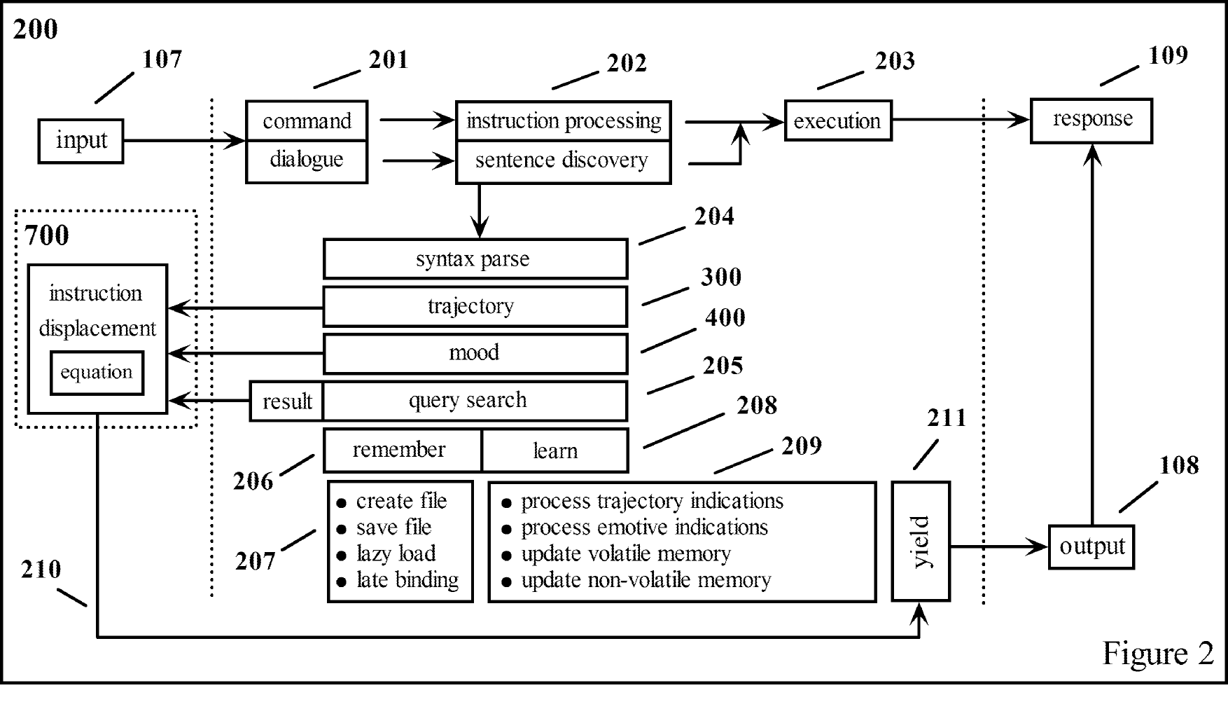

Referring now to FIG. 2, there is shown the input processing schematic for all embodiments of a cognitive-emotional conversational interaction system of the present invention consisting of the receiving input 107 from a participant 105, facilitated by the presence 101. Once an input 107 is received, the system determines whether the input 107 is a command or a dialogue 201.

In the case where a command is detected 201, the command is processed as an instruction 202, dependent upon the array of available instructions the system will understand 104, and set for execution 203 where it generates a response 109 based on the substance of the command, how the system is designed to respond upon receiving it from a participant 105, and the actions 500 used to express it.

In the case where verbal dialogue is detected 201, the sentence is discovered 202 by the system and it is prepared for syntax parsing 204 where the sentence is broken down into its constituent grammatical and syntactical forms, dependent upon the operating language of the system and of a participant 105. Once sentence discovery 202 has occurred, its components are prepared and a trajectory indication 311 is determined in order than a response 109 is provided which is relevant to what was input 107. When syntax parsing 204 is complete, the trajectory encapsulation 307 is prepared, as well as the yield 211 of the response 109 based upon the system's mood 405, where the system will prepare a query search 205 on what kind of response to generate based on categorical and pattern-discernable indications from the file 104 and memory 209 storage components. Once this process has completed, the system will remember 206 the dialogue at that point in time 308 by creating or adding to a file of a specific format, which in this example would be text, xml, or a scripting file, save the file, then introduce it to the presence 101 by either lazy loading the file or creating a late-binding assembly 207 or both, where applicable. The system will also attempt to learn 208 components of the dialogue by cross-referencing the dialogue component with the indications generated by the trajectory 311 as well as the emotive indications 404 from the mood 400 component. When these processing tasks are complete, the system will update either the volatile or the non-volatile memory 209 depending on which area of the system the changes are intended. Finally, the system will have a yield 211 to present to the output 108, which is passed as a response 109 to the original input 107.

In the case where gestural or tactile dialogue is detected 201, the intention is discovered in the same manner as the sentence 202 and is prepared for syntax parsing 204 where the intention is broken down into its constituent intentional forms, based upon its stored 104 catalog 306 of recognizable forms understood by a participant 105. When syntax parsing 204 is complete, the trajectory encapsulation 307 is prepared, as well as the yield 211 of the response 109 based upon the system's mood 405, where the system will prepare a query search 205 on what kind of gestural, vibrational, or audial response respective to what type was input correlated with those indications from the file 104 and memory 209 storage components. Once this process has completed, the system will remember 206 the dialogue at that point in time 308 by creating or adding to a file of a specific format, which in this example would be text, xml, or a scripting file, save the file, then introduce it to the presence 101 by either lazy loading the file or creating a late-binding assembly 207 or both, where applicable. The system will also attempt to learn 208 components of the dialogue by cross-referencing the dialogue component with the indications generated by the trajectory 311 as well as the emotive indications 404 from the mood 400 component. When these processing tasks are complete, the system will update either the volatile or the non-volatile memory 209 depending on which area of the system the changes are intended. Finally, the system will have a yield 211 to present to the output 108, which is passed as a response 109 to the original input 107 in the appropriate contextual format.

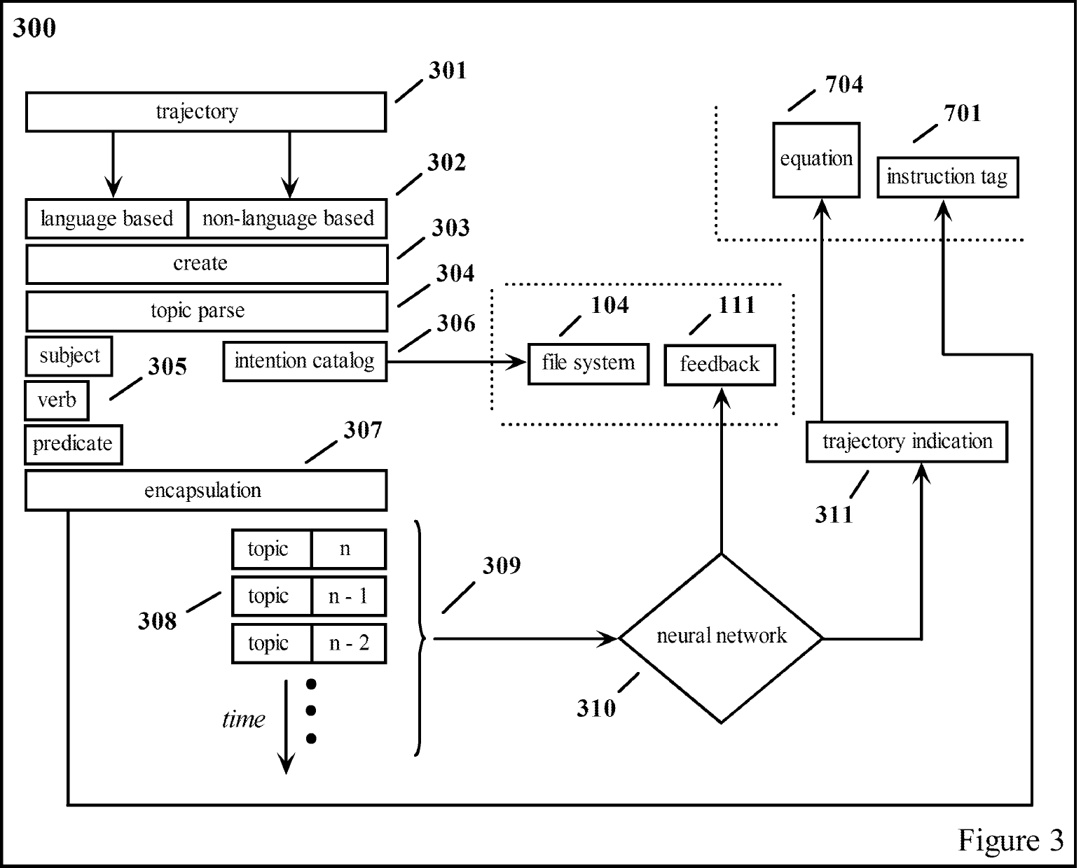

Referring now to FIG. 3, there is shown the trajectory indication processing schematic for all embodiments of a cognitive-emotional conversational interaction system of the present invention consisting of the trajectory 301, the component that attempts to determine logical meaning from what is input 107. A trajectory is created 303 based upon whether or not the trajectory 301 is language or non-language based 302; in the case of language, relevant to its syntactical style and based on the grammatical rules of the operating language between the presence 101 and a participant 105, the trajectory is disassembled into its constituent parts by parsing its topic 304 and its grammatical components, where in this example, has its rule base as subject-verb-predicate 305, and is encapsulated 307 for export to the instructional displacement 700 component via the instruction tag 701. The topic, which has been determined, along with the sentence's predicate, is arranged 308 in the order in which it has appeared. This content is presented 309 to a neural network 310 in order that a trajectory indication 311 is generated, consisting of a weighted value of the pattern in the network for that particular trajectory. The pattern encapsulated in the trajectory is passed as a parameter input to the characteristic equation 704. In the case of non-language, the trajectory is disassembled into its constituent parts by parsing its topic 304 where it is compared 306 with an index of intentions, or catalog, which is stored in the file system 104. It is then encapsulated 307 for export to the instructional displacement 700 component via the instruction tag 701. The intention, which has been determined, is arranged 308 in the order in which it has appeared. This content is presented 309 to a neural network 310 in order that a trajectory indication 311 is generated, consisting of a weighted value of the pattern in the network for that particular intention. The pattern encapsulated in the intention is passed as a parameter input to the characteristic equation 704.

The neural network 310 is, in this example, a feed-forward back-propagation type with an input, output, and hidden layers characteristic of those used in deep learning but could also be of any variety in the family of algorithmic autonomous learning, including self-organizing maps. The neural network 310 requires training 104 from previous trajectory 311 and emotive 404 indications, which are applied at startup 102. The actions presented by the neural network 310 as feedback 111 are distinct from those, which run when the system is learning 208 although when processing trajectory 311 and emotive 404 indications, the weights of the neural network could be read beforehand in order to reduce errors in the yield 211. In this case, the neural network is utilized to optimize, rather than directly providing decision-making tasks, those denoted by the architecture, layout, and flow of the system of the present invention.

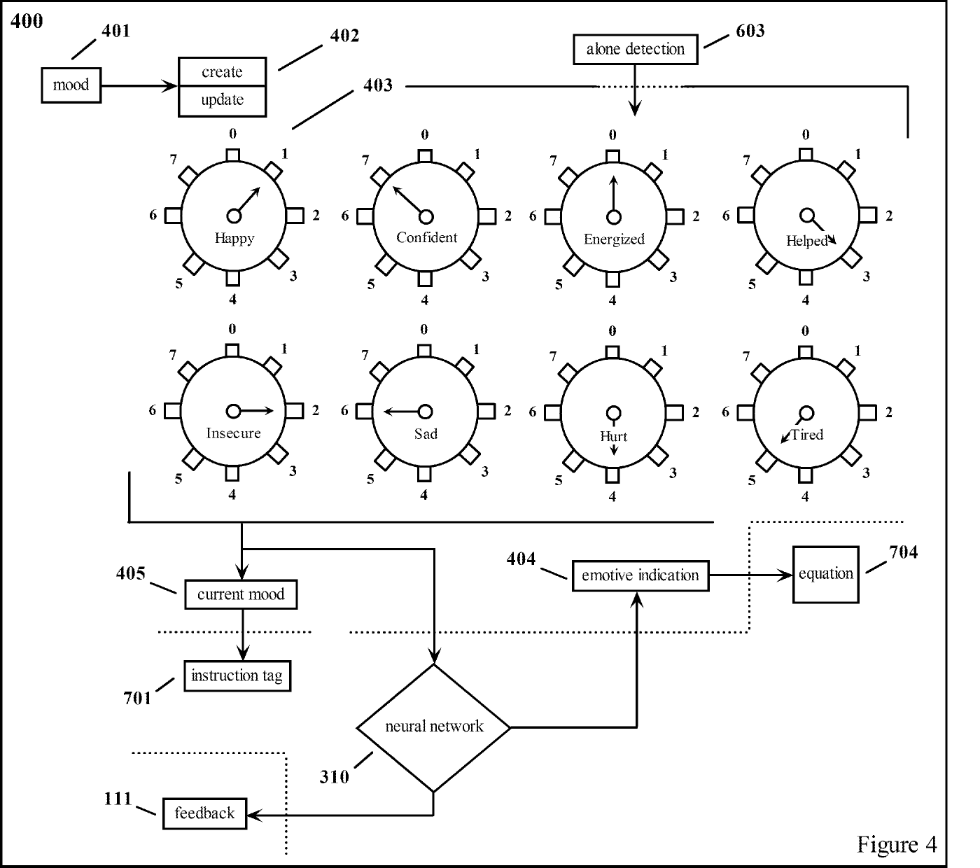

Referring now to FIG. 4, there is shown the emotional engine schematic for all embodiments of a cognitive-emotional conversational interaction system of the present invention, which is a mechanism to manifest the mood 401 of the system, in voice intonation, tactile, gestural, and animated response 500, which is utilized to exhibit feelings available to the presence 101 indicated by its current mood 405. When it is desirable the system manifest emotion, chosen by a participant 105, for the duration, or lifetime, of the presence 101, it will either create or update 402 the mood 401 depending on if it is the first instance or not. In either case, the engine 400 consists of a parent set of eight feelings: happy, confident, energized, helped, insecure, sad, hurt, or tired. For each set of parents, there is a child subset of seven moods corresponding to the assignments set forth in Table 1. For example, when mood 401 is created for the first time, a random choice is made based upon the allowable scope of the compendium of emotions, that is, a file containing the desired as well as the undesired feelings the system should manifest. Without any such file, the mood at creation would be a completely random occurrence. Once created 402, based upon the parent collection of feelings, a current mood 405 from the child collection is assigned, at random, and the conjoined set presented to the neural network 310 for emotive indication 404 assignment.

The emotions processed in the engine 400 are comprised of wheel-like elemental states 403 containing an arrangement of the parent feelings and child moods where each element keeps track of its last emotional state, set to the zeroth indication as default, which is the off state. For a given feeling, for example, happy, the indicator will point to an integer between one and seven, each corresponding to the available moods from left to right in column two of Table 1. When a mood is chosen, its current output state 405 is sent to the neural network 310 in order that an emotive indication 404 is generated, consisting of a weighted value of the pattern in the network for that particular mood. When the presence recognizes that it is alone 600, the detection 603 will enter into one of the emotional states.

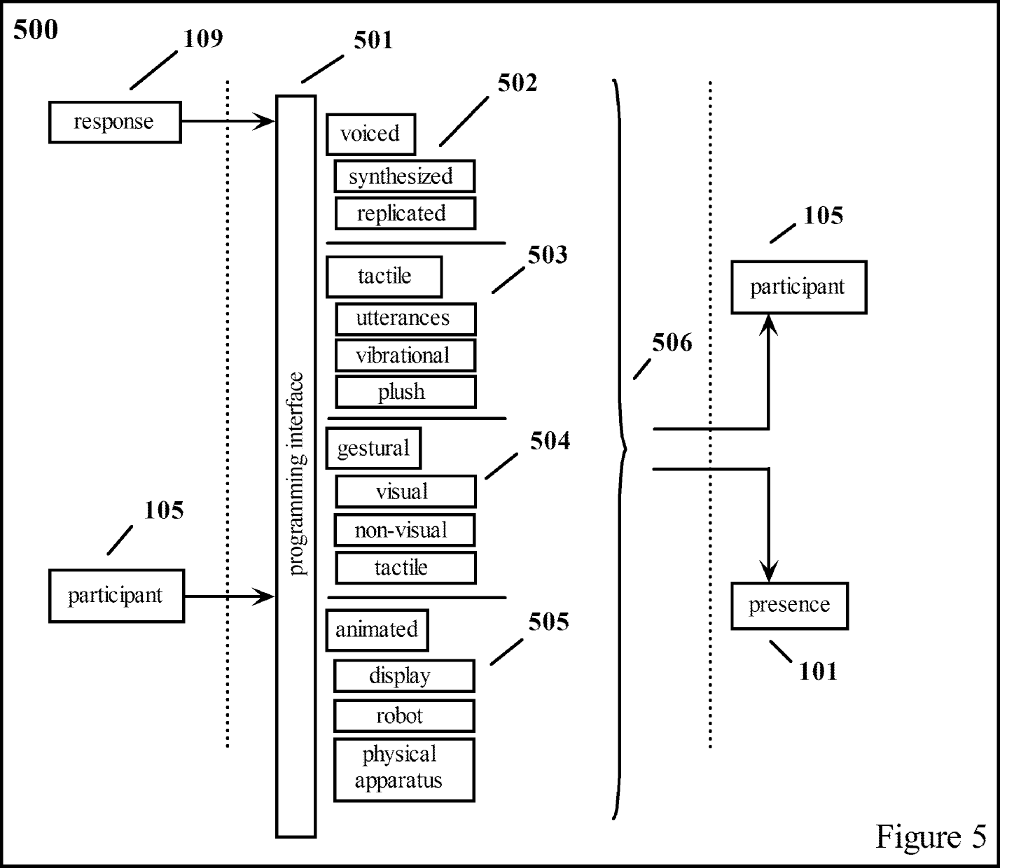

Referring now to FIG. 5, there is shown the response animation component for all embodiments of a cognitive-emotional conversational interaction system of the present invention consisting of an array of physical hardware or other apparatus to facilitate verbal and non-verbal communication between the presence 101 and a participant 105. Based on contextual trajectory 311 and emotive indications 404, as well as animating the emotive indications by a display, external application, robot, plush fabric, or appropriate physical apparatus capable of illustrating the substance of the meaning embedded in the emotive indication and dialogue response 109, it is passed to the animation component through a programming interface 501, which, in part, is supplied by the party who manufactured the corresponding hardware, such that it can be controlled by the presence 101. Depiction of verbal characteristics 502, a voice, for example, is synthesized, replicated, or otherwise assembled beforehand as to provide the desired tone, cadence, and gender to a participant 105. Depiction of tactile characteristics 503, non-language utterances such as chirps, purrs, whirrs, or other primitive audial, movements of plush components in fabrics, or vibrations in physical space or on a surface is presented to a participant 105 in such a manner. Depiction of gestural characteristics 504, visual or non-visual movement in the form of rotations in physical space are presented 506 to a participant 105 in such a manner. For animation of emotion and other complex visual movement 505, a display using still graphic files or progressive sequences of pictures, lights, or other physical apparatus appropriate to accurately and aesthetically present the meaning expected by the current mood 405. A robot can also be interfaced using the programming construct provided by the manufacturer 501 to animate the corresponding bodily gestures, send and receive data pertaining to responses by a participant 105, and perform complex puppeteering. The animation component is designed to display output to a participant as well as receive input from a participant; in the former case, it takes a response 109 and presents 506 an output, while in the latter case, it interprets cues from a participant 105 and prepares them for use by the presence 101.

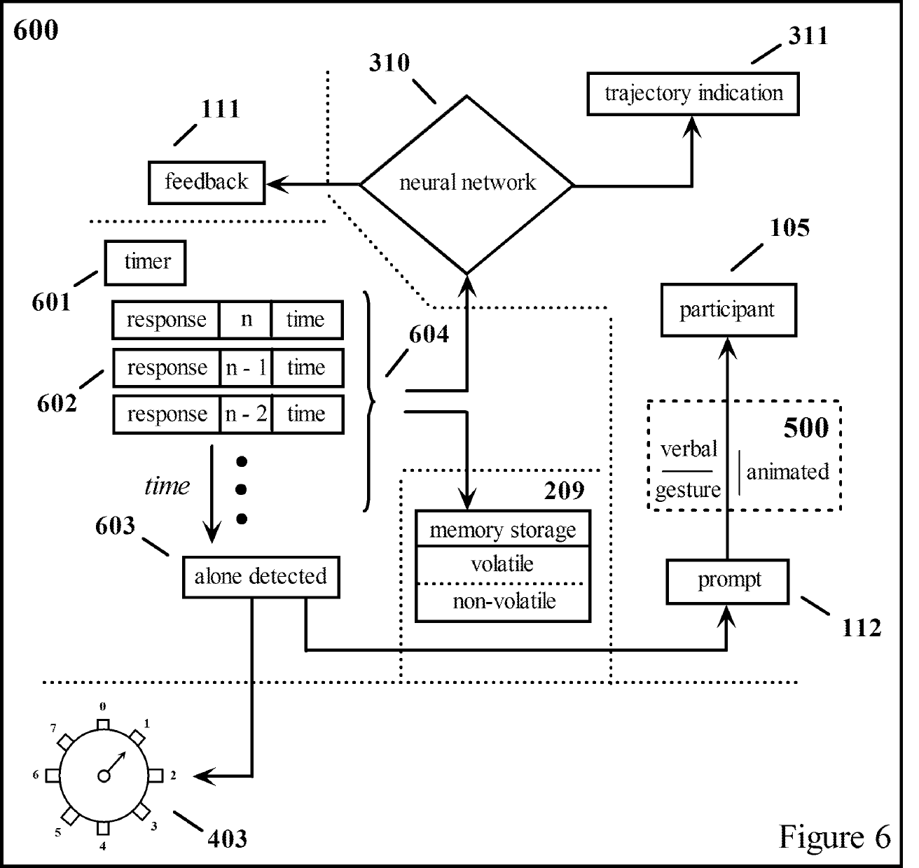

Referring now to FIG. 6, there is shown the alone component, response storage mechanism, and participant prompt for all embodiments of a cognitive-emotional conversational interaction system of the present invention consisting of a timer 601 of a duration set by a configuration file 104 determines how much time must pass before the presence 101 becomes alone, entering the corresponding emotional state 403. When alone is detected 603, the system sends a prompt 112 to the output animation 500, which is conveyed to a participant 105. During times when the presence 101 is not alone or is not set to become contemplative in the configuration file, responses 109 are collected 602, arranged by temporal order with its value noted, and stored in volatile and non-volatile memory 209; the former as an object, the latter in a file, for example, a transcript log file. It is also possible that the set of temporally arranged responses 602 be passed 604 to the neural network 310 for classification in order that it can influence the weights of the trajectory indications 311 and provide feedback 111.

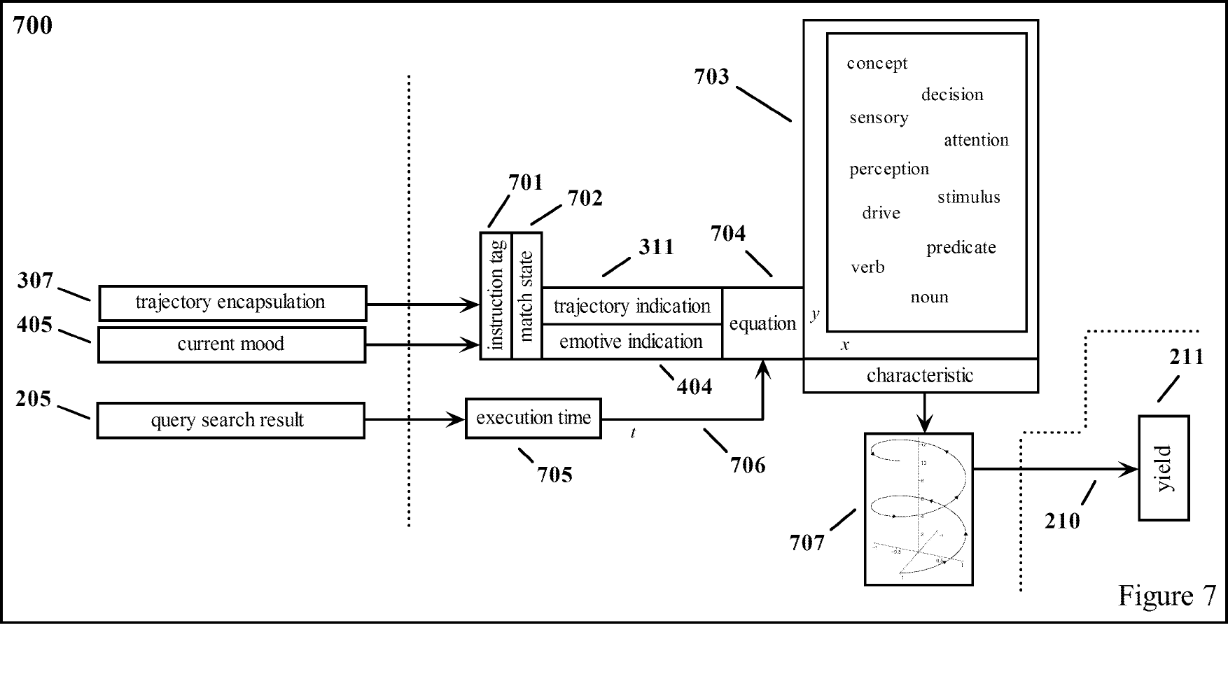

Referring now to FIG. 7, there is shown the instructional displacement sequence schematic for all embodiments of a cognitive-emotional conversational interaction system of the present invention consisting of a set of inputs coming from the trajectory encapsulation 307, the emotive aspect 400, and the query procedure 205 which provides data to the process of instructional displacement by first extracting the instruction tags 701 from the trajectory 300 and current mood 405 where the tags are analyzed in order their states are matched 702 and correlated with the corresponding trajectory indication 311 for the case of a trajectory, and corresponding emotive indication 404 for the case of a mood. The correlation yields a set of coordinates which become the x-coordinate, for example in the case of a trajectory indication 311, and the y-coordinate, for example in the case of an emotive indication 404. A temporal coordinate is yielded 706 by the execution time-marker 705 coming from the query search result 205, which becomes the variable t in the example of a parametric governing equation 704. This equation, by the choice of parameterization variables and function—for example any of the trigonometric, continuous differential functions, and/or polynomials—formats the data into a pattern of information which is classified into different coordinate blocks 703 based upon data embedded within either of the indications. The execution time 705 and its output value 706, gives the system a characteristic behavior of a particular continuous shape 707, for example, in the form of a helix given its execution function and the manner by which time is given over by the query procedure coupled with the hardware the system is running within. The information of form and function is provided 210 to the yield 211.

At the core of what is called the process of instructional displacement 700 is the block classifier 703, which, in this example, is described as the brain of the system and is designed to mimic the storage and information retrieval characteristics of a mammalian brain. Both trajectory 311 and emotive 404 indications feed data into the classifier 703 subsequent to interaction with a participant 105 where, depending on the choice of equation 704 and its parameterization, along with the execution time coming from the query procedure 205 and the execution of the program within the system and the hardware in which it is running, gives a set of unique displacements of information based upon those parts of the brain responsible for different phenomena exhibited by existence within a life-cycle, such as concepts, decisions, sensory experience, attention to stimuli, perceptions, aspects of stimulus in itself, drive meaning ambitions, and the syntactical nature of the language that the presence 101 is subject to—ordinarily the noun, verb, and predicate forms but also intentions 306.

Referring now to Table 1, there is shown the compendium of emotions for all embodiments of a cognitive-emotional conversational interaction system of the present invention consisting of a collection of parent feelings, in the left column, four positive and four negative connotations, with a corresponding collection of child moods, in the right column, of seven varieties. The parent feeling, when chosen by the presence 101 will exhibit those behaviors given the current mood 405, from minor elements of the emotive indication 404.

TABLE 1
Compendium of emotions

| Parent feelings | Child moods | | | | | | |
|---|---|---|---|---|---|---|---|
| Happy | Hopeful | Supported | Charmed | Grateful | Optimistic | Content | Loving |
| Confident | Strong | Certain | Assured | Successful | Valuable | Beautiful | Relaxed |
| Energized | Determined | Inspired | Creative | Healthy | Vibrant | Alert | Motivated |
| Helped | Cherished | Befriended | Appreciated | Understood | Empowered | Accepted | Loved |
| Insecure | Weak | Hopeless | Doubtful | Scared | Anxious | Stressed | Nervous |
| Sad | Depressed | Lonely | Angry | Frustrated | Upset | Disappointed | Hateful |
| Hurt | Forgotten | Ignored | Offended | Rejected | Hated | Mistreated | Injured |
| Tired | Indifferent | Bored | Sick | Weary | Powerless | Listless | Drained |

### REFERENCES CITED

U.S. PATENT DOCUMENTS

| 6,462,498 B1 | August 2002 | Filo |
|---|---|---|
| 2012/0041903 A1 | February 2012 | Beilby et al. |
| 2014/0122056 A1 | May 2014 | Duan |
| 2014/0122083 A1 | May 2014 | Xiaojiang |
| 2014/0250195 A1 | September 2014 | Capper et al. |
| 2014/0279050 A1 | September 2014 | Makar et al. |
| 2016/0203648 A1 | July 2016 | Bilbrey et al. |
| 2016/0260434 A1 | September 2016 | Gelfenbeyn et al. |
| 2016/0300570 A1 | October 2016 | Gustafson et al. |
| 2016/0302711 A1 | October 2016 | Frank et al. |
| 2016/0308795 A1 | October 2016 | Cheng et al. |
| 2016/0352658 A1 | December 2016 | Capper et al. |
| 2017/0180485 A1 | June 2017 | Lawson et al. |
| 2017/0230312 A1 | August 2017 | Barrett et al. |
| 2017/0344532 A1 | November 2017 | Zhou et al. |
| 2018/0032576 A1 | February 2018 | Romero |
| 2018/0052826 A1 | February 2018 | Chowdhary et al. |
| 5,966,526 | October 1999 | Yokoi |
| 6,832,955 B2 | December 2004 | Yokoi |
| 7,337,157 B2 | February 2008 | Bridges et al. |
| 7,505,892 B2 | March 2009 | Foderaro |
| 7,725,395 B2 | May 2010 | Rui et. al. |
| 7,962,578 B2 | June 2011 | Makar et al. |
| 8,630,961 B2 | January 2014 | Beilby et al. |
| 9,213,940 B2 | December 2015 | Beilby et al. |
| 9,369,410 B2 | June 2016 | Capper et al. |
| 9,794,199 B2 | October 2017 | Capper et al. |
| 9,847,084 B2 | December 2017 | Gustafson et al. |
| 9,858,724 | January 2018 | Friesen |

### OTHER PUBLICATIONS

Blocker, Christopher P. “Are we on the same wavelength? How emotional intelligence interacts and creates value in agent-client encounters.” 2010.
Castell, Alburey. 1949. “Meaning: Emotive, Descriptive, and Critical.” Ethics, Vol. 60, pp. 55-61, 1949.
El-Nasr, Magy Seif, Thomas R. Ioerger, and John Yen. “Learning and emotional intelligence in agents.” Proceedings of AAAI Fall Symposium. 1998.
Fan, Lisa, et al. “Do We Need Emotionally Intelligent Artificial Agents? First Results of Human Perceptions of Emotional Intelligence in Humans Compared to Robots.” International Conference on Intelligent Virtual Agents. Springer, Cham, 2017.
Fernández-Berrocal, Pablo, et al. “Cultural influences on the relation between perceived emotional intelligence and depression.” International Review of Social Psychology, Vol. 18, No. 1, pp. 91-107, 2005.
Fung, P. “Robots with heart.” Scientific American, Vol. 313, No 0.5, pp. 60-63, 2015.
Gratch, Jonathan, et al. “Towards a Validated Model of” Emotional Intelligence“.” Proceedings of the National Conference on Artificial Intelligence. Vol. 21. No. 2. Menlo Park, Calif.; Cambridge, Mass.; London; AAAI Press; MIT Press; 1999, 2006.
loannidou, F., and V. Konstantikaki. “Empathy and emotional intelligence: What is it really about?.” International Journal of caring sciences, Vol. 1, Iss. 3, pp. 118-123, 2008.
Kampman, Onno Pepijn, et al. “Adapting a Virtual Agent to User Personality.” 2017.
Mousa, Amal Awad Abdel Nabi, Reem Farag Mahrous Menssey, and Neama Mohamed Fouad Kamel. “Relationship between Perceived stress, Emotional Intelligence and Hope among Intern Nursing Students.”, IOSR Journal of Nursing and Health Science, Vol. 6, Iss. 3, 2017.
Niewiadomski, Radostaw, Virginie Demeure, and Catherine Pelachaud. “Warmth, competence, believability and virtual agents.” International Conference on Intelligent Virtual Agents. Springer, Berlin, Heidelberg, 2010.
Park, Ji Ho, et al. “Emojive! Collecting Emotion Data from Speech and Facial Expression using Mobile Game App.” Proc. Interspeech, pp. 827-828, 2017.
Reddy, William M. “Against Constructionism: The Historical Ethnography of Emotions.” Current Anthropology, Vol. 38, pp. 327-351, 1997.
Shawar, bayan Abu, and Eric Atwell. “Accessing an information system by chatting.” International Conference on Application of Natural Language to Information Systems. Springer, Berlin, Heidelberg, 2004.
Wang, Yingying, et al. “Assessing the impact of hand motion on virtual character personality.” ACM Transactions on Applied Perception (TAP), Vol. 13, No. 2, 2016.
Weiner, Norbert. “Cybernetics: Or Control and Communication in the Animal and the Machine.” Hermann & Cie, Paris, 1948.
Yang, Yang, Xiaojuan Ma, and Pascale Fung. “Perceived emotional intelligence in virtual agents.” Proceedings of the 2017 CHI Conference Extended Abstracts on Human Factors in Computing Systems. ACM, 2017.

1) A hardware-level implementation of a software construct which consists of a computer-based deployment of audial, verbal, non-verbal, tactile, and gestural communication between itself and a participant, commonly called a user, the method consisting the creation of a process hosted on a hardware or appropriate physical device, the first part an interactive session with a participant for the purposes of creating a contextual interactive exchange—a private and intimate relationship based upon conversational elements, tactile, vibrational, and visual cues—for the purposes of satisfying human emotional curiosities in the manner of: a collection of specifically-formatted files stored in non-volatile memory constituting a database which are loaded into the device's volatile memory when the system starts, to ensure a degree of reproducibility of behaviors exhibited by the system, which is, in this example, a collection of classes in an object-oriented language and a set of functions and scripts, creating a non-hierarchal arrangement of data extracted from the files according to embedded tags forming a categorical and pattern-identifiable repository of trajectories establishing contextual meaning communicated by a participant to determine an appropriate response that a participant will identify as relevant to what is intended by the dialogue, a hierarchical collection of ascribed behaviors and intentions containing a list of qualitative aspects with which to correlate audial, verbal, non-verbal, tactile, and gestural cues of the emotional state of the user relative to the construct; successive inputs from a participant are posited in the device's volatile memory which forms the second part of the process, a construct constituted to be a means to understand by remembering successive trajectories n, n−1, n−2, etcetera to establish within the system ascribed meaning of the interaction dynamically, the system learns each successive trajectory by neural network or other algorithmic learning strategy, classifies intention by way of mapping correlations, while the system creates additional files to be stored in non-volatile memory, added to the runtime by lazy loading or late assembly-binding providing the system an increased capacity to detect similar patterns in future exchanges by the method of the trajectory and emotive, saved into non-volatile memory as a backup if the system should terminate unexpectedly or if a participant wishes to stop and resume the interaction at a future time from its last point; simulation of emotion which forms the third part of the process establishing ascribed meaning accomplished by a component of the system called mood which utilizes one of a set of fifty-six assigned emotional states, comprised of a parent set of eight types with each having a further seven child subtypes, first determined at random and altered by indications based upon the trajectories and emotives of interaction dialogue and memory retrieval, displayed on a fixed or animated screen, exhibited tactilely in a plush fabric, interpreted by a robotic apparatus or other appropriate variations of hardware so that it convey simulated emotions to a participant; the sequence of successive audial, verbal, non-verbal, tactile, and gestural interactions given the trajectory of dialogue and the sequence of emotives created in volatile memory and written to files by the system in non-volatile memory later loaded into volatile memory contributes increases in performance by self-improvement, where growth is determined by experience with participant's personality manifesting an intentional proclivity toward a participant; awareness of the system's internal state forms the fourth part of the process, a construct constituted to be a means to recognize the lack of attention by a participant interpreted as being in an undesirable state commonly associated as being alone where the system prompts a participant in order that it not remain in the undesirable state.

2) The system according to claim 1, consists of four distinctive parts: creation of process, input processing and system expansion, simulation of emotional cues, and memory of its own internal state of interaction with relation to time when the last input was received, to manifest an output a participant would deem to contain contextual meaning by what was said.

3) The system according to claim 2, a neural network processes cues appearing in data processed and transformed by the system which assigns weighted values to sequences and compositions creating a mechanism where the neural network's output values change operating parameters of the system in the form of feedback as well as executing commands to store system parameters by writing and saving amendments to files formatted that the programming language understands.

4) The system according to claim 2, based on trajectory indications and input from a participant, animate the emotive indications by a display, external application, robot, plush fabric, or appropriate physical apparatus capable of illustrating the substance of meaning embedded in the emotive indication and dialogue response, in the following manner: verbal characteristics as voice synthesis or replication; tactile characteristics, non-language utterances such as chirps, purrs, whirrs, or other primitive audial, movements of plush components in fabrics, or vibrations in physical space or on a surface; gestural characteristics, visual or non-visual movement in the form of rotations in physical space; emotion and other complex visual movement, using still graphic files or progressive sequences of pictures, lights, or other physical apparatus appropriate to accurately and aesthetically present the meaning expected by the current mood; robotic apparatus to animate the corresponding bodily gestures, send and receive data pertaining to responses by a participant and perform complex puppeteering.

5) The system according to claim 4, by indications from trajectories of conversational dialogue, each one containing a category and pattern, and assigned a weighted value which, in totality, the sequence of successive verbal, non-verbal, tactile, vibrational, gestural, and animated interactions the system understands when presented by a participant.

6) The system according to claim 3, learns each successive trajectory and data-storage, information-retrieval sequence by neural network or other algorithmic learning strategy in the manner of natural language processing and/or deep learning constructs additionally processing new files, which could be formatted files the programming language understands xml, programming-language construct files, or scripts to be executed in volatile memory added back into the system by lazy loading or late-assembly binding byte code from non-volatile into volatile memory providing itself an increased capacity by self-improvement in order that it have a better ability to detect similar patterns in future exchanges.

7) The system according to claim 4, comprising the emotional impact of the system through simulation to establish the concept of meaning accomplished by a construct in the system called mood displayed on a fixed or animated screen, interpreted by a robotic apparatus or other appropriate variations of hardware relevant to particulars of a participant's personality so that it convey emotions in the manner that a participant would expect, for the purposes of creating an illusion of awareness and increased camaraderie.

8) The system according to claim 6, a set of inputs from trajectory encapsulation, emotive aspect, and query procedure which provides data to the construct of instructional displacement by first extracting instruction tags from trajectory and current mood where the tags are analyzed in order their states are matched and correlated with corresponding trajectory indication for the case of trajectory, and corresponding emotive indication for the case of mood. The correlation yields a set of coordinates, which become the x-coordinate in the case of a trajectory indication, and the y-coordinate in the case of an emotive indication. A temporal coordinate execution time-marker from query search result, which becomes the variable t in a parametric governing equation, by choice of parameterization variables and function—any of the trigonometric, continuous differential functions, and/or polynomials—formats data into a pattern of information classified into different coordinate blocks based upon data embedded within either of the indications.

9) The system according to claim 7, the emotional engine, comprised of wheel-like elemental states containing an arrangement of parent feelings and child moods where each element keeps track of its last emotional state, set to zeroth indication as default the off state. For a given state, the indicator points to an integer between one and seven, each corresponding to available moods the system emulates, sent to a neural network for emotive indication, a weighted value of the pattern in the network for that particular mood.

10) The system according to claim 9, monitor of interaction between the system and a participant for the span of time when the last input was received of a duration set by a configuration file when the system becomes alone, entering the corresponding emotional state sending a prompt for output animation conveyed to a participant.

11) The system according to claim 8, cues appearing in data transformed by the system as intent by a block classifier, the brain of the system mimicking storage and information retrieval characteristics of a mammalian brain. Trajectory and emotive indications provide the classifier, depending on the choice of the characteristic equation and its parameterization along with the execution time coming from the query procedure and the execution of the program within the system and hardware, a set of displacements responsible for different phenomena available to the system in context with its environment.
